(19) United States
(12) Patent Application Publication
(10) Pub. No.: US 2004/0265567 A1
(43) Pub. Date: Dec. 30, 2004

(54) Surface covering made of foamed material having an acoustic effect

(76) Inventor: Stefan Janzen, Borken (DE)

Correspondence Address: HARNESS, DICKEY & PIERCE, P.L.C., P.O. BOX 828, BLOOMFIELD HILLS, MI, 48303, US

(21) Appl. No.: 10/481,677

(22) PCT Filed: Jun. 19, 2002
(86) PCT No.: PCT/EP02/06795

(30) Foreign Application Priority Data
Jun. 21, 2001 (DE) 101 29 858.7

(51) Int. Cl. B32B 5/22; B32B 27/40; B05D 1/40; B05D 3/02

(52) U.S. Cl. 428/318.4; 428/423.1; 427/429; 427/385.5; 427/393.5

(57) ABSTRACT

The invention relates to a method for the surface coating of acoustically active foam materials, a corresponding foam material obtainable by this method, and the use of said foam.

The invention relates to a method for the surface coating of acoustically active foam materials, a corresponding foam material obtainable by this method, and the use of said foam.

The surface of acoustically active materials (damping or insulation materials) for the preparation of insulations, for example, in the automobile and construction fields, especially foams and fibrous webs, must frequently be covered for various reasons (stability, protection, optical reasons etc.); in the prior art, porous textile sheets, such as non-woven cover fabrics or woven fabrics, for example, are used for this purpose.

DE 197 34 532 A1 relates to an insulation element in composite design and a method for its preparation. It describes an insulation element in composite design having a layer laminated from mineral wool whose fiber orientation is perpendicular to the direction of the major axes of the element, and a method for its preparation, being based on the object of providing a preparation method and an insulation element which is to have comprehensive static conditions, such as strength properties, a great dimensional stability, good sound-protection properties and increased resistances against thermal and weathering loads, in addition to a broad applicability. This object is achieved by an insulation element whose laminated layer (one or more) having a perpendicular fiber orientation design is connected with layers of a similar material with a different fiber orientation or a different structured material, the layer structure of the element being arranged within the element once or in several repetitions. The method is characterized in that the supplied fibrous web is fed into the supplying transport means in several layers and guided within the means and moved towards the apex, and the separated laminae of the converted layer structures form corresponding bridge-like groups of laminae with respect to the number and material composition of the layers.

DE 197 34 943 A1 relates to a method for the production of a cladding element with insulation properties and a profiled surface. It describes a method for the production of a cladding element with insulation properties and a profiled surface whose base sheet which consists of a fibrous material, especially mineral wool, has a fiber path with an orientation perpendicular to the surface and a monolayer or multilayer design.

The underlying object is to prepare cladding and insulation elements with high productivity which have high service value properties, such as dimensional stability and flexural strength, with excellent insulation properties. This object is achieved by embossing, in a dry condition, the surface profile of a cladding or insulation element by means of a pressure directed perpendicular to the fibers standing upright on the surface to be profiled without an own addition of shape stabilizers as well as liquids, wherein the fibers and fiber areas exposed to the pressure of the embossing tool in concavely embossed areas of the profile are broken and/or irreversibly deformed at the surface.

DE 36 29 222 A1 relates to a process for producing a lining member, and to a lining member prepared by such process. In particular, it describes a process in which a fibrous material in single or multiple layer form is coated with a binder preferably comprising a modified polyester resin or the like, a foam plate is positioned on one side of the fibrous material which is covered with a non-woven fabric and compressed in a molding press, wherein a glass fiber non-woven fabric consisting of ultrafine glass fibers is used as the fibrous material.

U.S. Pat. No. 4,169,184 describes the preparation of an adhesive tape of a high-density, flexible, open-cell polyurethane foam impregnated throughout with a chlorine-containing elastomer and coated with a pressure-sensitive adhesive. The surface is not coated here, but soaked.

GB 1 029 407 A relates to the preparation of a foam sealing material and impregnation by soaking (at 90% compression and subsequent relaxation) to increase the resistance to media. In this case too, soaking of the surface is described rather than coating.

GB 984 300 A describes the soaking of polyurethane foams with isocyanates for the preparation of rigid open-cell foams and increasing the resistance to media. As in the above mentioned prior art, soaking of the surface is described rather than coating in this case too.

DE 693 08 608 T2 relates to a method and device for preparing a coated fibrous fabric. In a first step, a foamed or foaming-induced cross-linkable elastomeric aqueous emulsion coating composition is applied to the surface of a fibrous web to form a coating.

In a second step, a hot smooth ironing surface is closely conformed to the coating to dry and compress the coating and to develop a cured smooth surface film over the exposed area of the coating. Subsequently, the ironing surface is detached from said conforming to the coating, and the web of the coating is heated until the coating has been dried and cured. In a further step, the web is then obtained which is supposed to have a smooth and tough elastomeric cross-linking, coating on one surface of the web.

In contrast, the object of the present invention, in particular, is to provide an improved method for the surface coating of acoustically active foam materials. Another object of the present invention, in particular, is to provide surface-coated foam materials which ensure good dimensional stability, low flow resistance and as free as possible a choice of color of the surface coating.

In a first embodiment of the present invention, the above mentioned object is achieved by a method for the surface coating of acoustically active foam materials, characterized in that a coating is applied by means of a knife, roll, foam or reverse method while the foam is being compressed by the coating tool, and the coating is cured after the restoring of the foam material.

The coating method according to the invention is based on covering the surface of such materials, namely foams, but also fibrous materials, in principle, with an also porous, but at the same time rigid layer, wherein the surface properties sought can be very variable due to the selection of the coating in terms of selecting the ingredients. of the coating material. An advantage of coatings according to the invention is the concentration of the desired properties (such as resistance to media and/or flame protection) at the surface of the construction part rather than in the whole bulk of the construction part, which highly reduces the amount of aggregates employed.

It is particularly preferred for the coating to have the following properties:

stiffening of the cover layers of flexible materials to increase the flexural strength and compression strength; the desired strength and/or flexibility can be adjusted according to requirements;

permanent dimensional stability of coated and later deformed parts due to the use of thermosetting binders in the cover layer;

acoustically effective (open) due to the open structure, which is due to the ingredients of the coating compositions and the coating method;

free choice of color due to the incorporation of various pigments and fillers;

the mechanical and acoustic properties can be varied by corresponding adjustments of formulation, for example, by the addition of fibers and other fillers and binders to the coating composition;

by selecting appropriate ingredients of the coating compositions, additional product surface features can be adjusted, for example, hydrophobicity, oleophobicity, certain resistances to media, or flame protection.

The foam material to be coated is two-dimensionally coated with a composition under a pressing force, dried and, if required, subsequently deformed under the appropriate conditions (temperature/pressure).

The coating composition consists, for example, of binders, especially thermosetting ones, such as melamine resins, and variable proportions of aggregates, such as fillers, pigments, fibers, thickeners, flame protectants, hydrophobizing and/or oleophobizing agents in aqueous solution or dispersion. An advantage of melamine resins as binders is the flame retardant property of these materials, which is already very highly pronounced.

Depending on the coating method, various other auxiliaries, such as foaming agents or thickeners, are optionally used.

The application of the coating can be effected with the usual and known methods, such as knife coating, roll coating, foam coating or reverse method, wherein the formulation should be adapted accordingly. According to the invention, it has been found that a highly open porous surface is achieved by a slight pressure of the application tool onto the surface of the coated material when the coating is effected with a concentrated coating composition. It is also possible to conceive application of a stabilized foam layer, wherein the foam structure is to be retained even after drying and setting to retain the open-pore property.

At first, drying is effected at temperatures below the cross-linking temperature of the respective binder, unless planar parts which are not further deformed are desired, so that drying and condensing can be performed immediately.

The preparation of molded parts is optionally effected in a shaping tool at the temperatures and times which correspond to the binder and other aggregates.

The foam materials according to the invention can be employed in the constructional field, for example, for acoustic ceilings or walls, or in the automotive field as a cover web substitute on suitable acoustically active building parts.

It is particularly preferred according to the present invention to employ a semi-rigid open-pore foam as the foam material. The term. “semi-rigid light-weight foam” as used in the present invention includes, in particular, those having a compression stress within a range of from 20 to 40 kPa, especially from 25 to 25 kPa, and/or a density of from 10 to 25 kg/m³.

The compression stress of a foam material is another of the measurable quality criteria which relates to its ability to provide comfort.

The testing of the compression stress is usually effected with a standardized testing body of 100×100×50 mm, which is precompressed three times at first before the measurement of the compression stress is effected in the fourth compression cycle at 40% compression.

A force flow diagram exhibits the different compression stresses under various amounts of pressure, preferably between 10 and 55%. It is found that the relief curve runs below the load curve, because the relaxing of the foam only releases part of the energy which was previously applied for loading.

The internal energy absorption of the foam is a measure of its elasticity. The greater the difference between the load and release compression stresses, the less is the elasticity.

The term “semi-rigid light-weight foams” as used within the present invention includes, in particular, those having a density of 12 to 17 kg/m³. This density can be measured, for example, according to DIN 53420 or ISO 845.

In a particular embodiment of the present invention, a polyurethane foam is employed as the material of the foam. However, in addition, any other foam material can be employed according to the invention.

It is particularly preferred according to the present invention to employ as the coating a melamine resin solution or solutions as well as dispersions of phenol resins, polyurethanes or acrylates which optionally contain fillers, fibers, binders, flame retardants, flexibilizers, hydrophobizing agents, oleophobizing agents, dyes, pigments, foaming agents, emulsifiers and/or thickeners. Alternatively with the solutions and/or dispersions, polyurethane foams may also be applied.

The method according to the invention is characterized, in particular, by a pressing force of the application tool. This pressing force is determined, for example, by adjusting the compression of the foam material with the application tool within a range of from 5 to 30%, especially from 5 to 10%, of the thickness of the foam material.

The curing of the coating applied according to the invention, especially a thermo-setting coating, is preferably effected within a temperature range of above 100° C., especially at a temperature of above 140° C.

It is particularly preferred according to the present invention to effect a deformation of the foam material before the coating has cured. This is all the more true with thermosetting coating materials which serve as supports for the foam material.

Another embodiment of the present invention includes the foam material provided with a surface coating which is obtainable by the above mentioned method.

Due to the application of the coating, the basis weight of the foam material increases by the mass of the coating. Accordingly, the foam material coated according to the invention is preferably characterized by having an increase in basis weight of from 20 to 1000 g/m², especially from 100 to 300 g/m², when coated on one side.

An essential object of the present invention is to provide a foam material which has excellent acoustic properties. The flow resistance is known to be a characteristic quantity of a porous sound-absorption material. The sound-absorbing properties of a porous material depend on its flow resistance. It is particularly preferred according to the present invention for the uncoated foam material to have a flow resistance according to DIN 52213 of from 200 to 10,000 Ns/m³, especially from 500 to 5000 Ns/m³; The flow resistance of the coated foam material should be on the same order of magnitude.

Another embodiment of the present invention is the use of the above mentioned foam materials for the preparation of acoustic ceilings in the constructional field or as a cover web substitute in acoustically active building parts in the automotive field.

### EXAMPLE 1

A semi-rigid open-cell polyurethane light-weight. foam having a density of about 16 kg/m³ was coated. The exemplary coating composition was as follows:

| | |
|---|---|
| melamine resin solution | 66% |
| (30% Madurit ® MW396, Solutia GmbH, in water) | |
| tinter (Faust Vollton-Abtönfarbe black) | 22% |
| acryl dispersion | 11% |
| (ready-to-use mixture supplied by Vegro, Kirschau) | |
| thickener (Raniegel ® NK24D) | 1%. |

Sheets with the format DIN A4 and a thickness of 20 mm were coated with the coating composition using a trowel and processed under a slight pressing force. Drying and cross-linking were performed in a circulating air drying oven at 150° C. The corresponding masses applied are given in Table 1 .

The determination of porosity was effected by means of a differential pressure measuring device supplied by Schmohl, Eislingen (based on pressurized air flowing through the object to be measured and determination of the flow resistance in mbar), at 4 points each of the specimens before and after coating. In this case too, the corresponding data are given in Table 1.

### EXAMPLE 2

By analogy with Example 1, the same sheets were provided with a different mass applied. The values are stated in Table 1.

### COMPARATIVE EXAMPLE 1

By analogy with Example 1, a sheet coated on one side thereof with a cover web (Libeltex 0114214010, 120 g/m²) and having the format DIN A4 and a thickness of 20 mm was covered with the cover web. Table 1 states the data obtained.

### COMPARATIVE EXAMPLE 2

By analogy with Example 1, coating was effected with a coating knife only superficially without a pressing force worth mentioning. The results are given in Table 1.

### EXAMPLE 3

By analogy with Example 1, coating was effected with a coating knife under increased pressing force at an angle of about 45° in the moving direction of the application tool. In this case too, the pressing force produced a compression of the material of about 2 mm. Table 1 states the data obtained.

TABLE 1
Flow resistance

| | Mass | | Mean value | | Mean value |
|---|---|---|---|---|---|
| Example | applied [g] | Uncoated, mbar | uncoated, mbar | Coated, mbar | coated, mbar |
| 1 | 11.7 | 250/225/340/325 | 285 | 160/165/160/220 | 176 |
| 2 | 10.9 | 220/260/250/290 | 255 | 170/130/210/290 | 200 |
| 3 | 13.4 | 245/240/200/230 | 229 | 195/440/315/280 | 307 |
| Comp. 1 | Cover web | 370/230/325/220 | 286 | 420/265/390/280 | 339 |
| Comp. 2 | 13.51 | 220/210/245/230 | 226 | 330/450/370/530 | 420 |

1. A method for the surface coating of acoustically active foam materials, characterized in that a coating is applied by means of a coating application tool while the foam is being compressed by the application tool, and the coating is cured after the restoring of the foam material.

2. The method according to claim 1, characterized in that a semi-rigid open-pore light-weight foam having a compression stress within a range of from about 20 to 40 kPa, is employed.

3. The method according to claim 1, characterized in that a polyurethane foam is employed as the foam material.

4. The method according to claim 1, characterized in that thermosetting plastics which optionally contain fillers, fibers, binders, flame protectants, flexibilizers, hydrophobizing agents, oleophobizing agents, dyes, pigments, foaming agents, emulsifiers and/or thickeners are employed as the coating agent.

5. The method according to claim 1, characterized in that melamine resins, phenol resins, polyurethane resins and/or acrylate resins are employed as the coating agent.

6. The method according to claim 1, characterized in that the compression of the foam material is adjusted with the application tool to within a range of from about 5 to 30%, of the thickness of the foam material.

7. The method according to claim 1, characterized in that the curing is effected at a temperature above 100° C.

8. The method according to claim 1, characterized in that a deformation of the foam material is effected before the coating has cured.

9. A foam material provided with a surface coating obtainable by the method according to claim 1.

10. The foam material according to claim 9, characterized by having a basis weight of the coating of from about 20 to 1000 g/m², when coated on one side.

11. The foam material according to claim 9, characterized by having a flow resistance according to DIN 52213 of from about 200 to 10,000 Ns/m³.

12. Use of the foam material according to claim 9 for the preparation of acoustic panels.

13. The method according to claim 1 characterized in that said semi-rigid open pore light-weight foam has a compressions tress of from about 25 to kPa.

14. The method according to claim 1 characterized in that said semi-rigid open pore light-weight foam has a density of between about 10 to 25 kg/m³.

15. The method according to claim 1 characterized in that said semi-rigid open pore light-weight foam has a density of between about 12 to 17 kg/m³.

16. The method according to claim 1 characterized in that the compression of the foam material is adjusted with the application tool to within a range of from about 5 to 10% of the thickness of the foam material.

17. The foam material according to claim 9, characterized by having a basis weight of the coating of from about 100 to 300 g/m² when coated on one side.

18. The foam material according to claim 9, characterized by having a flow resistance according to DIN 52213 of from about 500 to 5000 Ns/m³.
